(19) United States
(12) Patent Application Publication
(10) Pub. No.: US 2026/0025639 A1
(43) Pub. Date: Jan. 22, 2026

(54) POSITIONING A TERMINAL APPARATUS USING A RADIO LINK WITH A REFERENCE APPARATUS

(71) Applicant: Nokia Technologies Oy, Espoo (FI)

(72) Inventors: Prajwal KESHAVAMURTHY, Munich (DE); Diomidis MICHALOPOULOS, Munich (DE); Ali KARIMIDEHKORDI, Munich (DE); Daniel MEDINA, Munich (DE); Amir Mehdi AHMADIAN TEHRANI, Munich (DE); Alessio MARCONE, Munich (DE); Leonardo CHIARELLO, Munich (DE)

(21) Appl. No.: 19/099,874

(22) PCT Filed: Aug. 10, 2023
(86) PCT No.: PCT/IB2023/058108

§ 371 Date: Jan. 30, 2025

(30) Foreign Application Priority Data
Sep. 26, 2022 (GB) 2214008.1

(51) Int. Cl. H04W 4/029; G01S 5/02; H04W 64/00; H04W 76/14

(52) U.S. Cl. CPC H04W 4/029; G01S 5/0236; H04W 64/00; H04W 76/14

(57) ABSTRACT

A terminal apparatus comprising means for: positioning the terminal apparatus in a first positioning session using a radio link with at least a reference apparatus; detecting degradation in radio link quality of the radio link between the terminal apparatus and the reference apparatus; transmitting positioning assistance information, via sidelink communication, to at least another terminal apparatus in dependence upon the detected degradation in radio link quality of the radio link between the terminal apparatus and the reference apparatus, wherein the positioning assistance information is indicative of at least a degradation in the radio link quality of the radio link between the terminal apparatus and the reference apparatus.

### TECHNOLOGICAL FIELD

Examples of the disclosure relate to positioning a terminal apparatus using a radio link with a reference apparatus.

### BACKGROUND

It is desirable to be able to position a terminal apparatus. This can be achieved using at least a radio link with a reference apparatus.

Different positioning algorithms can be used. Examples include time difference of arrival (TDOA), round trip time (RTT), angle of arrival/departure (AOA/D) etc.

A positioning algorithm can for example use multiple distances from references (multi-lateration). A positioning algorithm can for example use multiple angles from references (multi-bearing). A positioning algorithm can for example use angle(s) and distances from one or more references.

The positioning of a terminal apparatus can for example comprise the determination of a relative position, for example, relative to a reference apparatus. The positioning of a terminal apparatus can for example comprise the determination of an absolute position. For example, provide 2D/3D geographic coordinates (e.g., latitude, longitude, elevation) within a coordinate system. The positioning of a terminal apparatus can for example comprise ranging, for example, relative to a reference apparatus. For example, a distance to a reference apparatus.

The position of the terminal apparatus 10 can, for example, be used for vehicle-to-everything, public safety, industrial machinery positioning and industrial-internet-of-things.

It is desirable to improve positioning of a terminal apparatus.

### BRIEF SUMMARY

According to various, but not necessarily all, examples there is provided a terminal apparatus comprising means for:
positioning the terminal apparatus in a first positioning session using a radio link with at least a reference apparatus;
detecting degradation in radio link quality of the radio link between the terminal apparatus and the reference apparatus;
transmitting positioning assistance information, via sidelink communication, to at least another terminal apparatus in dependence upon the detected degradation in radio link quality of the radio link between the terminal apparatus and the reference apparatus,
wherein the positioning assistance information is indicative of at least a degradation in the radio link quality of the radio link between the terminal apparatus and the reference apparatus.

In some but not necessarily all examples, the radio link comprises reception of a radio positioning reference signal transmitted from the reference apparatus to the terminal apparatus and/or comprises transmission of a radio positioning reference signal from the terminal apparatus to the reference apparatus.

In some but not necessarily all examples, the radio positioning reference signal is a sidelink positioning reference signal.

In some but not necessarily all examples, the terminal apparatus is a target to be positioned and the reference apparatus is an anchor supporting positioning of the terminal apparatus in the first positioning session in a first sidelink network, and wherein the another terminal apparatus is a target to be positioned and the reference apparatus is an anchor supporting positioning of the another terminal apparatus in a second positioning session between the another terminal apparatus and the reference apparatus in a second sidelink network.

In some but not necessarily all examples, the reference apparatus is a network node and the radio positioning reference signal is a downlink positioning reference signal transmitted from the reference apparatus to the terminal apparatus and/or the radio positioning reference signal is an uplink positioning reference signal transmitted from terminal apparatus to the reference apparatus.

In some but not necessarily all examples, the means for detecting degradation in radio link quality between the terminal apparatus and the reference apparatus comprises means for detecting radio link failure or means for anticipating radio link failure based on measurement of radio link quality over time.

In some but not necessarily all examples, the apparatus comprises means for determining the positioning assistance information at least in dependence upon the detected degradation in radio link quality of the radio link between the terminal apparatus and the reference apparatus.

In some but not necessarily all examples, the positioning assistance information identifies at least one of the following:
an identifier of the reference apparatus;
a position of the reference apparatus;
a position of the terminal apparatus;
mobility pattern of the terminal apparatus;
positioning service level of the positioning session;
time-frequency resources of the radio positioning reference signal communicated over the radio link;
cause of degradation in radio link quality of the radio link between the terminal apparatus and the reference apparatus;
duration of degradation in radio link quality of the radio link between the terminal apparatus and the reference apparatus; or
information associated with alternative reference apparatus for positioning the another terminal apparatus in the second positioning session.

In some but not necessarily all examples, the apparatus comprises means for transmitting an interruption notification capability via sidelink communication, to the another terminal apparatus in advance of transmitting the positioning assistance information, via sidelink communication, to the another terminal apparatus, wherein the interruption notification capability is indicative of a capability of the terminal apparatus to provide the positioning assistance information.

In some but not necessarily all examples, the apparatus comprises means for receiving an interruption notification request via sidelink communication, from the another terminal apparatus in advance of transmitting positioning assistance information, via sidelink communication, to the another terminal apparatus, wherein the positioning assistance information is determined at least in dependence upon the interruption notification request.

In some but not necessarily all examples, the interruption notification request comprises at least one of the following:
an identifier of reference apparatus positioning the another terminal apparatus in the second positioning session;
mobility pattern of the another terminal apparatus; or
condition for transmitting the positioning assistance information.

In some but not necessarily all examples, the apparatus is configured as a user equipment comprising a radio transceiver for communication with a cell node of a radio access network, wherein the sidelink communication is between the user equipment and other user equipment

without using the radio access network.

According to various, but not necessarily all, examples there is provided a computer program that, when run on a computer of a terminal apparatus, performs:
positioning the terminal apparatus in a first positioning session using a radio link with at least a reference apparatus;
detecting degradation in radio link quality of the radio link between the terminal apparatus and the reference apparatus;
causing transmission of positioning assistance information, via sidelink communication, to at least another terminal apparatus in dependence upon the detected degradation in radio link quality of the radio link between the terminal apparatus and the reference apparatus,
wherein the positioning assistance information is indicative of at least a degradation in the radio link quality of the radio link between the terminal apparatus and the reference apparatus.

According to various, but not necessarily all, examples there is provided a method performed at a terminal apparatus comprising:
positioning the terminal apparatus in a first positioning session using a radio link with at least a reference apparatus;
detecting degradation in radio link quality of the radio link between the terminal apparatus and the reference apparatus;
transmitting positioning assistance information, via sidelink communication, to at least another terminal apparatus in dependence upon the detected degradation in radio link quality of the radio link between the terminal apparatus and the reference apparatus,
wherein the positioning assistance information is indicative of at least a degradation in the radio link quality of the radio link between the terminal apparatus and the reference apparatus.

According to various, but not necessarily all, examples there is provided a terminal apparatus comprising means for:
positioning the terminal apparatus in a second positioning session using a radio link with at least a first reference apparatus;
receiving from another terminal apparatus positioning assistance information, via sidelink communication, wherein the positioning assistance information is indicative of at least a degradation in radio link quality of a radio link between the another terminal apparatus and a second reference apparatus; and
in dependence upon the received positioning assistance information, determining performance of pre-emptive action in anticipation of degradation in the radio link between the terminal apparatus and the first reference apparatus.

In some but not necessarily all example, the radio link comprises reception of a radio positioning reference signal transmitted from the first reference apparatus to the terminal apparatus and/or comprises transmission of a radio positioning reference signal from the terminal apparatus to the first reference apparatus.

In some but not necessarily all examples, the radio positioning reference signal is a sidelink positioning reference signal.

In some but not necessarily all examples, the terminal apparatus is a target to be positioned and the first reference apparatus is an anchor supporting positioning the terminal apparatus in the second positioning session in a second sidelink network, and wherein the another terminal apparatus is a target to be positioned and the second reference apparatus is an anchor supporting positioning the another terminal apparatus in a first positioning session between the another terminal apparatus and the second reference apparatus in a first sidelink network.

In some but not necessarily all examples, the apparatus comprises means for performing pre-emptive action, said means comprising means for modifying the second positioning session and/or means for terminating the second positioning session.

In some but not necessarily all examples, the apparatus comprises means for transmitting an interruption notification request via sidelink communication, to the another terminal apparatus, requesting the another terminal apparatus to provide the positioning assistance information.

In some but not necessarily all examples, the interruption notification request comprises at least one of the following:
an identifier of the first reference apparatus positioning the terminal apparatus in the second positioning session;
mobility pattern of the terminal apparatus; or
condition for transmitting the positioning assistance information.

In some but not necessarily all examples, the positioning assistance information identifies at least one of the following:
Identifier of the second reference apparatus;
a position of the second reference apparatus;
a position of the another terminal apparatus;
mobility pattern of the another terminal apparatus;
positioning service level of the first positioning session positioning the another terminal apparatus;
time-frequency resources of radio positioning reference signal communicated in the first positioning session over the radio link between the another terminal apparatus and the second reference apparatus;
cause of degradation in radio link quality of the radio link between the another terminal apparatus and the second reference apparatus;
duration of degradation in radio link quality of the radio link between the another terminal apparatus and the second reference apparatus; or
information associated with alternative reference apparatus for positioning the terminal apparatus in the second positioning session.

In some but not necessarily all examples, the terminal apparatus comprises means for receiving an interruption notification capability via sidelink communication, from the other terminal apparatus in advance of transmitting the interruption notification request, via sidelink communication, to the another terminal apparatus, wherein the interruption notification capability is indicative of a capability of the another terminal apparatus to provide the positioning assistance information.

In some but not necessarily all examples, the first reference terminal apparatus is the second reference terminal apparatus.

According to various, but not necessarily all, examples there is provided a computer program that, when run on a computer of a terminal apparatus, performs:
positioning the terminal apparatus in a second positioning session using a radio link with at least a first reference apparatus;
causing reception from another terminal apparatus of positioning assistance information, via sidelink communication, wherein the positioning assistance information is indicative of at least a degradation in radio link quality of a radio link between the another terminal apparatus and a second reference apparatus;
in dependence upon the received positioning assistance information, determining performance of pre-emptive action in anticipation of degradation in the radio link between the terminal apparatus and the first reference apparatus.

According to various, but not necessarily all, examples there is provided a method performed at a terminal apparatus comprising:
positioning the terminal apparatus in a second positioning session using a radio link with at least a first reference apparatus;
receiving from another terminal apparatus positioning assistance information, via sidelink communication, wherein the positioning assistance information is indicative of at least a degradation in radio link quality of a radio link between the another terminal apparatus and a second reference apparatus;
in dependence upon the received positioning assistance information, determining performance of pre-emptive action in anticipation of degradation in the radio link between the terminal apparatus and the first reference apparatus.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

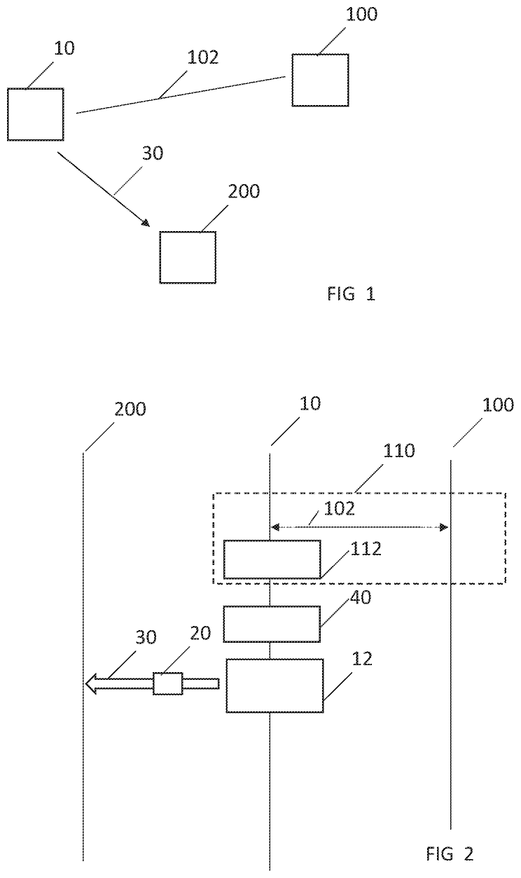

FIG. 1 shows an example of the subject matter described herein;

FIG. 2 shows another example of the subject matter described herein;

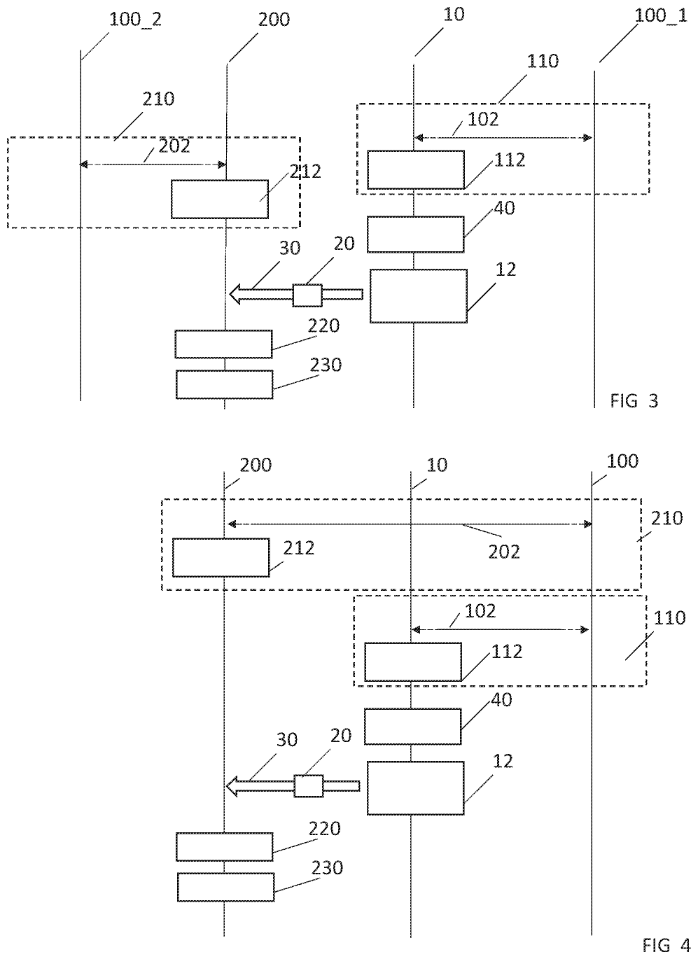

FIG. 3 shows another example of the subject matter described herein;

FIG. 4 shows another example of the subject matter described herein;

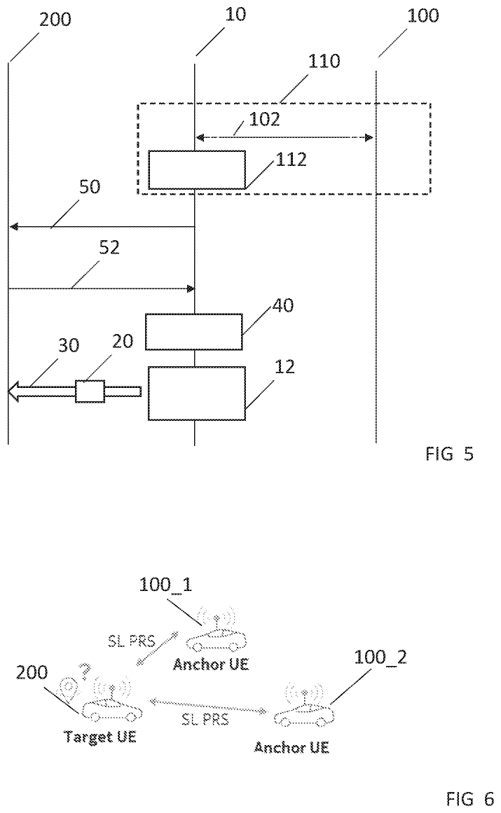

FIG. 5 shows another example of the subject matter described herein;

FIG. 6 shows another example of the subject matter described herein;

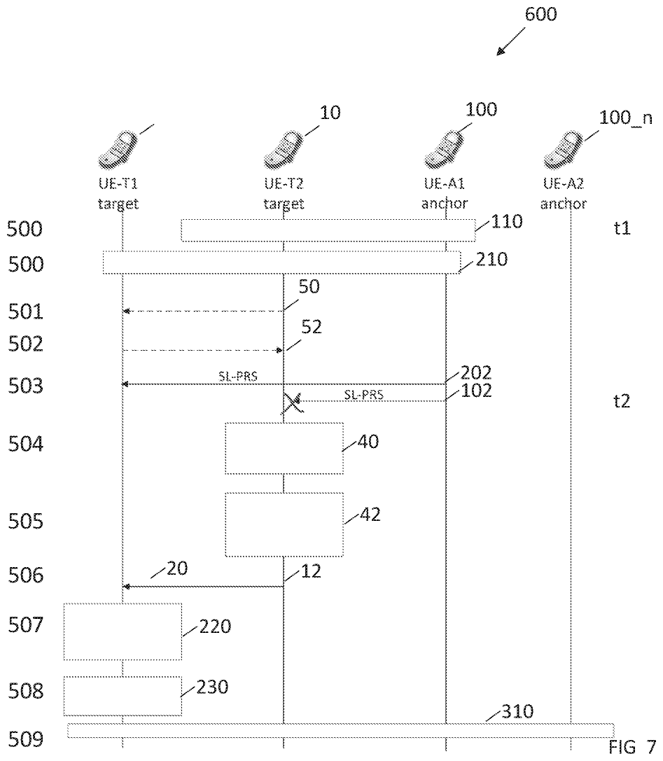

FIG. 7 shows another example of the subject matter described herein;

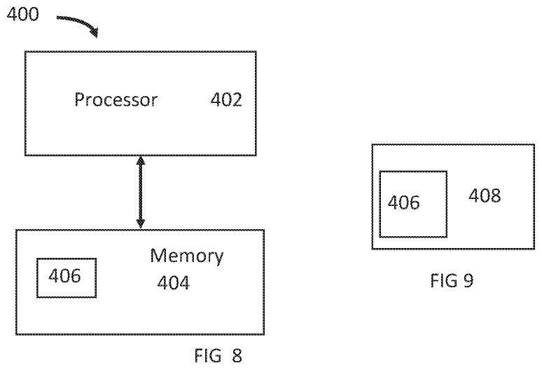

FIG. 8 shows another example of the subject matter described herein;

FIG. 9 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### DETAILED DESCRIPTION

FIG. 1 illustrates an example of a system comprising a terminal apparatus 10, a reference apparatus 100, and another terminal apparatus 200.

There is a sidelink communication 30 from the terminal apparatus 10 to the other terminal apparatus 200.

There is a radio link 102 between the terminal apparatus 10 and the reference apparatus 100.

The radio link 102 is used for positioning the terminal apparatus 10 during a positioning session.

Different positioning algorithms can be used. Examples include time difference of arrival (TDOA), round trip time (RTT), angle of arrival/departure (AOA/D) etc.

A positioning algorithm can for example use multiple distances from references (multi-lateration). A positioning algorithm can for example use multiple angles from references (multi-bearing). A positioning algorithm can for example use angle(s) and distances from one or more references.

The positioning of a terminal apparatus can for example comprise the determination of a relative position, for example, relative to a reference apparatus.

The positioning of a terminal apparatus can for example comprise the determination of an absolute position. For example, provide 2D/3D geographic coordinates (e.g., latitude, longitude, elevation) within a coordinate system.

The positioning of a terminal apparatus can for example comprise ranging, for example, relative to a reference apparatus. For example, a distance to a reference apparatus.

The position of the terminal apparatus 10 can, for example, be used for vehicle-to-everything, public safety, industrial machinery positioning and industrial-internet-of-things.

The radio link 102 can be a uni-directional link either from or to the terminal apparatus 10 or can be a bi-directional link to and from the terminal apparatus 10.

In at least some examples, the radio link 102 comprises reception of a radio positioning reference signal transmitted from the reference apparatus 100 to the terminal apparatus 10 and/or comprises transmission of a radio positioning reference signal from the terminal apparatus 10 to the reference apparatus 100.

In one example, the reference apparatus 100 is a network node and the radio positioning reference signal is a downlink positioning reference signal transmitted from the reference apparatus 100 to the terminal apparatus 10 and/or the radio positioning reference signal is an uplink positioning reference signal transmitted from terminal apparatus 10 to the reference apparatus 100. The network node can, for example, be a transmission-reception point (TRP) or a base station (e.g. gNB)

In another example, the radio positioning reference signal is a sidelink positioning reference signal. In this example, the reference apparatus 100 is user equipment. A sidelink positioning reference signal can be transmitted in any appropriate channel. A sidelink positioning reference signal can be transmitted in a new physical sidelink channel or in an existing channel e.g. Physical Sidelink Shared Channel (PSSCH) or Physical Sidelink Feedback Channel (PSFCH).

The terminal apparatus 10 is a target to be positioned and the reference apparatus 100 is an anchor supporting positioning of the terminal apparatus 10 which is in a positioning session in a sidelink network.

Although only a single radio link 102 to one reference apparatus 100 is illustrated. In other examples (not illustrated), there may be multiple radio links 102 to multiple respective reference apparatus 100.

In some examples, the multiple radio links 102 comprise only sidelink communications. In some examples, the multiple radio links 102 comprise only radio access network communications (uplink/downlink). In some examples, the multiple radio links 102 comprise a mix of sidelink communications and radio access network communications (uplink/downlink).

In some examples, the terminal apparatus 10 comprises a radio transceiver for communication with a node of a radio access network (not illustrated) and the terminal apparatus 200 comprises a radio transceiver for communication with a node of a radio access network. The sidelink communication 30 comprises the transfer of information between terminal apparatus 10, 200 without using the radio access network. Sidelink communication 30 uses a direct radio link between the terminal apparatus 10, 200 to transfer information between terminal apparatus 10, 200 without using the radio access network.

In some examples, the terminal apparatus 10 is configured as a user equipment comprising a radio transceiver for communication with a cell node of a radio access network, and the terminal apparatus 200 is configured as a user equipment comprising a radio transceiver for communication with a cell node of the radio access network. The sidelink communication 30 is between the user equipment 10 and the user equipment 200 without using the radio access network.

In some but not necessarily all examples sidelink communication 30 uses:
frequency resources of the radio access network e.g., FR1, FR2; and/or a frame structure of the radio access network e.g., 10 ms radio frame divided into 10 subframes; and/or
modulation of the radio access network e.g., OFDM modulation with cyclic prefix; and/or
flexible OFDM numerology of radio access network e.g. Each OFDM numerology is defined by a subcarrier spacing (SCS) for the OFDM waveform and a cyclic prefix. SCS can, for example, be equal to 15 kHz, 30 kHz, 60 kHz or 120 KHz. In some examples, at lower frequencies (e.g. FR1) 15 kHz, 30 KHz and 60 kHz are supported for the SCS, while 60 kHz and 120 KHz are supported for the SCS at higher frequencies (e.g. FR2). Larger SCS results in a shorter slot duration

In some but not necessarily all examples sidelink resource allocation and link adaptation are performed by the user equipment (not the radio access network).

In some but not necessarily all examples sidelink range is hundreds of meters.

In some but not necessarily all examples sidelink communication supports Hybrid Automatic Repeat request (HARQ).

In some but not necessarily all examples sidelink communication supports beam-forming.

In some but not necessarily all examples sidelink dedicated channels include:
1) Physical Sidelink Control Channel (PSCCH): carries control information in the sidelink.
2) Physical Sidelink Shared Channel (PSSCH): carries data payload in the sidelink and additional control information.
3) Physical Sidelink Broadcast Channel (PSBCH): carries information for supporting synchronization in the sidelink. PSBCH is sent within a sidelink synchronization signal block (S-SSB).
4) Physical Sidelink Feedback Channel (PSFCH): carries feedback related to the successful or failed reception of a sidelink transmission.

Demodulation reference signal (DMRS) which is used by a receiver for decoding the associated sidelink physical channel, i.e., PSCCH, PSSCH, PSBCH is sent within the associated sidelink physical channel.

Sidelink Channel state information reference signal (SL CSI-RS) is used for measuring channel state information (CSI) at the receiver that is then fed back to the transmitter. The transmitter can adjust its transmission based on the fed back CSI.

Sidelink Phase-tracking reference signal (SL PT-RS) is used for mitigating the effect of phase noise (in particular at higher frequencies) resulting from imperfections of the oscillator. SL PT-RS is sent within the PSSCH region of the slot.

As illustrated in FIG. 2 (and FIGS. 3 & 4), the terminal apparatus 10 comprises means for:
positioning 112 the terminal apparatus 10 in a first positioning session 110 using a radio link 102 with at least a reference apparatus 100;
detecting 40 degradation in radio link quality of the radio link 102 between the terminal apparatus 10 and the reference apparatus 100;
transmitting 12 positioning assistance information 20, via sidelink communication 30, to at least another terminal apparatus 200 in dependence upon the detected degradation in radio link quality of the radio link 102 between the terminal apparatus 10 and the reference apparatus 100,
wherein the positioning assistance information 20 is indicative of at least a degradation in the radio link quality of the radio link between the terminal apparatus 10 and the reference apparatus 100.

The description of a positioning session using the radio link 102 with reference apparatus 100 provided above, for FIG. 1, is also relevant for the positioning session 110 using the radio link 102 with at least a reference apparatus 100 illustrated in FIG. 2 (and FIGS. 3 & 4).

In the example illustrated, the terminal apparatus 10 is configured as a user equipment and comprises a radio transceiver (not illustrated) for communication with a cell node of a radio access network (not illustrated). The sidelink communication 30 is between the user equipment 10 and other user equipment (the terminal apparatus 200) without using the radio access network. In at least some examples, the sidelink communication 30 comprises a data payload comprising the positioning assistance information 20.

In some, but not necessarily all examples, the means for detecting 40 degradation in radio link quality in the radio link between the terminal apparatus 10 and the reference apparatus 100 comprises means for detecting radio link 102 failure or means for anticipating radio link 102 failure based on measurement of radio link quality over time.

Any suitable measurement can be used to assess radio link quality of the radio link 102. For example, received signal strength can be used. For example, signal to noise ratio can be used. For example, in Third Generation Partnership Project (3GPP) one or more of Received Signal Strength Indicator (RSSI), Reference Signal Received Power (RSRP) and Reference Signal Received Quality (RSRQ) can be used.

The assessment of radio link quality of the radio link 102 can be constrained to the frequency resources used by the radio link 102.

Detecting 40 degradation in radio link quality can, for example, be achieved by comparing a suitable parameter (for dependent upon one or more of the measurements referred to above) against a suitable threshold. The comparison can, in some examples comprise an integration of the suitable parameter over a time window before making the comparison.

Detecting 40 degradation in radio link quality can, for example, be achieved using machine learning. For example, a neural network can be trained to recognize a pattern of parameters (for example dependent upon the measurements referred to above) as indicative of quality degradation, for example indicative of imminent future failure of the radio link 102.

In some, but not necessarily all examples, the means for detecting 40 degradation in radio link quality in the radio link 102 between the terminal apparatus 10 and the reference apparatus 100 comprises means for detecting radio link 102 failure or means for anticipating radio link 102 failure based on measurement of radio link quality over time.

In some but not necessarily all examples, the apparatus 10 comprises means for determining the positioning assistance information 20 at least in dependence upon the detected degradation in radio link quality of the radio link 102 between the terminal apparatus 10 and the reference apparatus 100.

For example, the content of the positioning assistance information 20 can vary with the degradation detected in radio link quality of the radio link 102 between the terminal apparatus and the reference apparatus 100.

The positioning assistance information 20 enables the other terminal apparatus 200 to take pre-emptive action in anticipation of failure of a radio link that the other terminal apparatus 10 200 is using or could use.

The content of the positioning assistance information 20 can be controlled to provide the other terminal apparatus 200 with information that will assist the other terminal apparatus 200 in anticipating failure of a radio link that the other terminal apparatus 200 is using or could use.

The positioning assistance information 20 transmitted by the terminal apparatus 100 to the other terminal apparatus 200 can for example identify one or more of the following:
an identifier of the reference apparatus 100;
a position of the reference apparatus 100;
a position of the terminal apparatus 10;
a mobility pattern of the terminal apparatus 10;
positioning service level of the positioning session 110;
time-frequency resources of the radio positioning reference signal communicated over the radio link 102;
cause of degradation in radio link quality of the radio link 102 between the terminal apparatus 10 and the reference apparatus 100;
duration of degradation in radio link quality of the radio link 102 between the terminal apparatus 10 and the reference apparatus 100; or
information associated with alternative reference apparatus 100 for positioning the another terminal apparatus 200 in the second positioning session 110.

The cause of degradation in radio link quality of the radio link 102 between the terminal apparatus 10 and the reference apparatus 100 can, for example, arise from a changing characteristic of the terminal apparatus 10 (e.g. speed), a changing characteristic of the reference apparatus 100 (e.g. speed), a changing characteristic of a spatial relationship between the terminal apparatus 10 and the reference apparatus 100 (e.g. distance, multi-path, physical obstructions), a characteristic of the radio environment (e.g. interference).

A positioning service level of a positioning session 110 can, for example, specify a required accuracy and/or required latency. The degradation in the radio link quality of the radio link 102 between the terminal apparatus 10 and the reference apparatus 100 can be defined relative to the current positioning service level of the positioning session 110.

The transmitting 12 of the positioning assistance information 20, via sidelink communication 30, to at least another terminal apparatus 200 can be as a unicast, groupcast, or broadcast message.

The transmitting 12 of the positioning assistance information 20, via sidelink communication 30, can for example be to multiple other terminal apparatus 200.

The description of a positioning session using the radio link 102 with reference apparatus 100 provided above, for FIG. 1, is also relevant for the positioning session 210 using the radio link 202 with at least a reference apparatus 100_2 illustrated in FIG. 3.

The operation of the terminal apparatus 10 in FIG. 3 is as previously described with reference to FIG. 2 except that the reference apparatus 100 is references as the first reference apparatus 100_1.

The terminal apparatus 10 is a target to be positioned and the reference apparatus 100_1 is an anchor supporting positioning of the terminal apparatus 10 in the first positioning session 110 in a first sidelink network.

The another terminal apparatus 200 is a target to be positioned and the reference apparatus 100_2 is an anchor supporting positioning of the other terminal apparatus 200 in a second positioning session 210 between the other terminal apparatus 200 and the reference apparatus 100 in a second sidelink network.

The positioning of the Terminal apparatus 10 can be independent of the positioning of the terminal apparatus 200. For example, the terminal apparatus 10 positions itself using the reference apparatus 100_1 not the other terminal apparatus 200 as a reference and the other terminal apparatus 200 positions itself using the reference apparatus 100_2 not the terminal apparatus 10 as a reference.

In FIG. 3 a terminal apparatus 200 comprises means for:
positioning 212 the terminal apparatus 200 in a second positioning session 210 using a radio link 202 with at least a first reference apparatus 100_2;
receiving from another terminal apparatus 10 positioning assistance information 20, via sidelink communication 30, wherein the positioning assistance information 20 is indicative of at least a degradation in radio link quality of a radio link 102 between the other terminal apparatus 10 and a second reference apparatus 100_2; and
in dependence upon the received positioning assistance information 20, determining 220 performance of pre-emptive action 230 in anticipation of degradation in the radio link 202 between the terminal apparatus 200 and the first reference apparatus 100_2.

In at least some examples, the radio link 202 comprises reception of a radio positioning reference signal transmitted from the first reference apparatus 100_2 to the terminal apparatus 200 and/or comprises transmission of a radio positioning reference signal from the terminal apparatus 200 to the first reference apparatus 100_2.

As previously described, in at least some examples, a radio positioning reference signal is a sidelink positioning reference signal and the first reference apparatus 100_2 is user equipment. The terminal apparatus 200 is a target to be positioned and the first reference apparatus 100_2 is an anchor positioning the terminal apparatus 200 in the second positioning session 210 in a second sidelink network, and wherein the another terminal apparatus 10 is a target to be positioned and the second reference apparatus 100_1 is an anchor positioning the another terminal apparatus 10 in a first positioning session 210 between the another terminal apparatus 10 and the second reference apparatus 100_1 in a first sidelink network.

As previously described, in other examples, the reference apparatus 100 is a network node and the radio positioning reference signal is a downlink positioning reference signal transmitted from the reference apparatus 100 to the terminal apparatus 10 and/or the radio positioning reference signal is an uplink positioning reference signal transmitted from terminal apparatus 10 to the reference apparatus 100.

In some but not necessarily all examples, determining 220 performance of pre-emptive action 230 in anticipation of degradation in the radio link 202, in dependence upon the received positioning assistance information 20, comprises determining 220 whether or not to perform pre-emptive action 230.

In some but not necessarily all examples, determining 220 performance of pre-emptive action 230 in anticipation of degradation in the radio link 202, in dependence upon the received positioning assistance information 20, comprises determining 220 what action occurs pre-emptively.

It should be noted that it is the terminal 10 that detects 40 degradation in radio link quality of the radio link 102 between the terminal apparatus 10 and the reference apparatus 100. This detection triggers action at the terminal apparatus 200 via the positioning assistance information 20. The terminal 200 does not detect degradation in radio link quality of the radio link 202 between the terminal apparatus 200 and the reference apparatus 100_2. Instead, it relies upon the receipt of the positioning assistance information 20 to provide information that can be used to anticipate (predict) degradation in the radio link 202 between the terminal apparatus 200 and the first reference apparatus 100_2. The action taken is pre-emptive because it occurs before detection by measurement of degradation in the radio link 202 between the terminal apparatus 200 and the first reference apparatus 100_2.

In some but not necessarily all examples, the apparatus 200 comprises means for performing pre-emptive action 230.

In at least some examples, the means for performing pre-emptive action 230 comprises means for modifying the second positioning session 210 and/or means for terminating the second positioning session 210.

The second positioning session 210 can, for example, be modified to use different time-frequency resources for the radio link 202 between the terminal apparatus 200 and the first reference apparatus 100_2.

The second positioning session 210 can, for example, be terminated and a new positioning session started using a new radio link between the terminal apparatus 200 and a new reference apparatus 100_n.

In at least some examples, the means for performing pre-emptive action 230 comprises means for configuring or re-configuring a radio link used for positioning.

The radio link 202 can for example be re-configured and use a different time-frequency resource.

A new radio link can for example be configured to a new reference apparatus 100_n.

In FIG. 3, the first reference apparatus 100_2 and the second reference apparatus 100_1 can be different apparatus or can be the same apparatus.

FIG. 3, illustrates an example where the first reference apparatus 100_2 and the second reference apparatus 100_1 are different apparatus. FIG. 4, illustrates an example where the first reference apparatus 100_2 and the second reference apparatus 100_1 are the same apparatus. The description above provided for FIG. 3 is also relevant for FIG. 4.

In FIG. 4 a terminal apparatus 200 comprises means for:
positioning 212 the terminal apparatus 200 in a second positioning session 210 using a radio link 202 with at least a first reference apparatus 100;
receiving from another terminal apparatus 10 positioning assistance information 20, via sidelink communication 30, wherein the positioning assistance information 20 is indicative of at least a degradation in radio link quality of a radio link 102 between the other terminal apparatus 10 and the reference apparatus 100; and
in dependence upon the received positioning assistance information 20, determining 220 performance of pre-emptive action 230 in anticipation of degradation in the radio link 202 between the terminal apparatus 200 and the reference apparatus 100.

In many cases, both targets 10, 200 are in positioning session 110, 210 with the same anchor 100. However, this is not always the case. Consider the case of jamming or high interference in a resource pool, then even if the anchors 100_1, 100_2 are different, target 200 can still benefit from receiving the positioning assistance information 20 because jamming and high interference in a resource pool may affect potentially all radio links (from different anchors 100_n) in the respective resource pool.

FIG. 5 illustrates example of modifications that can be made to any of the preceding examples. For simplicity of explanation, the modifications are explained as additions to the process illustrated in FIG. 2.

The apparatus 10 comprises means for transmitting an interruption notification capability 50 via sidelink communication 30, to the other terminal apparatus 200 in advance of transmitting the positioning assistance information 20, via sidelink communication 30, to the other terminal apparatus 200.

The interruption notification capability 50 is indicative to the other terminal apparatus 200 of a capability of the terminal apparatus 10 to provide the positioning assistance information 20.

The interruption notification capability 50 transmitted by the terminal apparatus 100 to the other terminal apparatus 200 can for example identify one or more of the following:
an identifier of the reference apparatus 100 (or other reference apparatus used for positioning);
a position of the terminal apparatus 10;
a mobility pattern of the terminal apparatus 10;
a positioning service level of the positioning session 110;
time-frequency resources of the radio positioning reference signal communicated over the radio link 102;
information associated with alternative reference apparatus 100 for positioning the another terminal apparatus 200 in the second positioning session 110.

The interruption notification capability 50 transmitted by the terminal apparatus 100 to the other terminal apparatus 200 can for example identify one or more of the following:
a characteristic of the terminal apparatus 10 (e.g. speed),
a characteristic of the reference apparatus 100 (e.g. speed),
a characteristic of a spatial relationship between the terminal apparatus 10 and the reference apparatus 100,
a characteristic of the radio environment (e.g. interference).

In some but not necessarily all examples, the interruption notification capability 50 is processed by the terminal apparatus 200. The terminal apparatus 200 can be configured to transmit an interruption notification request 52 to the terminal apparatus 10, in dependence upon the received interruption notification capability 50 from the terminal apparatus 10.

The interruption notification capability 50 is indicative to the other terminal apparatus 200 of a capability of the terminal apparatus 10 to provide positioning assistance information 20. If the positioning assistance information 20 provided by the terminal apparatus 10 is likely to assist determining 220 performance of pre-emptive action 230 in anticipation of degradation in the radio link 202 between the terminal apparatus 200 and the first reference apparatus 100_2 then the terminal apparatus 200 transmits an interruption notification request 52 to the terminal apparatus 10. If the positioning assistance information 20 provided by the terminal apparatus 10 is unlikely to assist determining 220 performance of pre-emptive action 230 in anticipation of degradation in the radio link 202 between the terminal apparatus 200 and the first reference apparatus 100_2 then the terminal apparatus 200 does not transmit an interruption notification request 52 to the terminal apparatus 10.

For example, if the location of the terminal apparatus 200 is similar to the location of the terminal apparatus 10 then the terminal apparatus 200 transmits an interruption notification request 52 to the terminal apparatus 10. For example, if the location of the terminal apparatus 200 is not similar to the location of the terminal apparatus 10 then the terminal apparatus 200 does not transmit an interruption notification request 52 to the terminal apparatus 10.

For example, if a mobility pattern of the terminal apparatus 200 is similar to a mobility pattern of the terminal apparatus 10 then the terminal apparatus 200 transmits an interruption notification request 52 to the terminal apparatus 10. For example, if the mobility pattern of the terminal apparatus 200 is not similar to the mobility pattern of the terminal apparatus 10 then the terminal apparatus 200 does not transmit an interruption notification request 52 to the terminal apparatus 10.

In some examples, the terminal apparatus 10 transmits positioning assistance information 20 only after receiving an interruption notification request 52, or the terminal apparatus 10 transmits positioning assistance information 20 using unicast only after receiving an interruption notification request 52.

In some examples, the terminal apparatus 10 transmits positioning assistance information 20 without receiving an interruption notification request 52, or the terminal apparatus 10 transmits positioning assistance information 20 using broadcast or groupcast without receiving an interruption notification request 52.

The terminal apparatus 200 comprises means for transmitting an interruption notification request 52 via sidelink communication 30, to the terminal apparatus 10, requesting the terminal apparatus 10 to provide the positioning assistance information 20.

The interruption notification request 52 transmitted by the terminal apparatus 200 to the terminal apparatus 10 can for example identify one or more of the following:
an identifier of the reference apparatus 100 used for positioning the terminal apparatus 200 in the second positioning session 210;
a mobility pattern of the terminal apparatus 200; or
a condition for transmitting the positioning assistance information 20.

In at least some examples, the apparatus 10 comprises means for receiving an interruption notification request 52 via sidelink communication 30, from the terminal apparatus 200 in advance of transmitting positioning assistance information 20, via sidelink communication 30, to the other terminal apparatus 200, wherein the positioning assistance information 20 is determined at least in dependence upon the interruption notification request 52.

The terminal apparatus 200 can comprise means for receiving an interruption notification capability 50 via sidelink communication 30, from the terminal apparatus 10 in advance of transmitting the interruption notification request 52, via sidelink communication 30, to the another terminal apparatus 10. The interruption notification capability 50 is indicative of a capability of the terminal apparatus 10 to provide the positioning assistance information 20.

It will be appreciated from the foregoing that FIGS. 1 to 5 illustrate examples of a method performed at a terminal apparatus 10 comprising:
positioning 112 the terminal apparatus 10 in a first positioning session 110 using a radio link 102 with at least a reference apparatus 100;
detecting 40 degradation in radio link quality of the radio link 102 between the terminal apparatus 10 and the reference apparatus 100;
transmitting 12 positioning assistance information 20, via sidelink communication 30, to at least another terminal apparatus 200 in dependence upon the detected degradation in radio link quality of the radio link 102 between the terminal apparatus 10 and the reference apparatus 100,
wherein the positioning assistance information 20 is indicative of at least a degradation in the radio link quality of the radio link between the terminal apparatus 10 and the reference apparatus 100.

It will be appreciated from the foregoing that FIGS. 1 to 5 illustrate examples of a method performed at a terminal apparatus 10 comprising:
positioning 212 the terminal apparatus 200 in a second positioning session 210 using a radio link 202 with at least a first reference apparatus 100_2;
receiving from another terminal apparatus 10 positioning assistance information 20, via sidelink communication 30, wherein the positioning assistance information 20 is indicative of at least a degradation in radio link quality of a radio link 102 between the other terminal apparatus 10 and a second reference apparatus 100_1; and
in dependence upon the received positioning assistance information 20, determining 220 performance of pre-emptive action 230 in anticipation of degradation in the radio link 202 between the terminal apparatus 200 and the first reference apparatus 100_2.

FIGS. 6 and 7 relate to various examples of the system previously described.

Performance requirements for different positioning service levels include, for example, one or more of the following key-performance-indices (KPIs) such as:
horizontal and vertical accuracy, where vertical accuracy refers to accuracy in altitude and determines the floor for indoor use cases and to distinguish between superposed tracks for road and rail use cases (e.g. bridges).
positioning service availability: percentage value of the amount of time the positioning service is delivering the required position-related data within the performance requirements, divided by the amount of time the system is expected to deliver the positioning service according to the specification in the targeted service area
positioning service latency: time elapsed between the event that triggers the determination of the position-related data and the availability of the position-related data at the system interface time to first fix (TTFF): time elapsed between the event triggering for the first time the determination of the position-related data and the availability of the position-related data at the positioning system interface
Update rate
Energy consumption, etc.

Applications of positioning include vehicle-to-everything (V2X), public safety, commercial and industrial-internet-of-things (IIoT).

Example applications include:
Lane level positioning requirement' use cases such as vehicle platooning, cooperative lane merge, lane change warning, emergency break warning, intersection movement assist, etc., Below meter positioning requirement' use cases such as high definition sensor sharing, vulnerable road user (VUR)—collision risk warning, cooperative maneuvers in emergency situations, real-time situation awareness and high-definition maps, etc.

Factories of the Future scenarios such as augmented reality in smart factories, mobile control panels with safety functions in smart factories (within factory danger zones), inbound logistics for manufacturing (for driving trajectories (if supported by further sensors like camera, GNSS, IMU) of indoor autonomous driving systems)).

In the following:
Sidelink (SL) refers to user equipment (UE) to UE communication as described above Target UE refers to a UE to be positioned.
Anchor UE refers to a UE supporting positioning of a target UE, e.g., by transmitting and/or receiving reference signals for positioning, over SL interface
Sidelink Positioning Reference Signal (SL PRS) refers to a reference signal transmitted over SL for positioning purposes.
SL PRS (pre-)configuration is a term that collectively refers to (pre-)configured parameters of SL PRS such as time-frequency resources including its bandwidth and periodicity; directivity-related parameters, e.g., beam direction, beam width, number of beams; and transmit power, etc.

SL positioning is based on the transmissions of SL-PRS by multiple anchor UEs to be received by a target UE (or SL-PRS exchange between the anchor and target UEs) to enable localization of the target UE within precise latency and accuracy requirements of the corresponding SL positioning session.

FIG. 6 illustrates a SL positioning scenario where a target UE 200 is performing SL positioning session i.e., exchanging SL-PRS with two anchors UE 100_1, 100_2 in order to determine its location. Here, the anchors 100_1, 100_2 are said to provide SL-PRS assistance (incl. SL-PRS) to the target UE 200.

(Re)establishing (or (re)configuring) a SL position session is expensive for the target UE in terms of delay since it involves anchor selection and SL-PRS configuration.

Chosen anchors can satisfy a set of conditions pertaining to resource availability (available energy+time/frequency resources) as well as to relative location of the anchors to ensure the required positioning accuracy at the target UE. The latter aspect relates to the fact that if the selected anchors are collinear with the target UE, the target UE experiences high geometric dilution of precision (GDOP), and the location precision is diluted. Hence, a target UE may employ different techniques such as ranging between the target UE and the candidate anchors or exchange some assistance information (e.g. beam-specific measurements, gNB-specific measurements between target and candidate anchors during the (re)selection of anchors.

The target UE may need to exchange assistance information on SL-PRS configuration (e.g. recommended SL-PRS resources) with the anchors (i.e. perform series of handshake) to avoid SL-PRS conflict at the target UE.

Additional series of handshakes between the target and each anchor in order to establish which entities are involved, what type of signaling and what type of reports are required to finalize the session, etc.

A SL positioning session may be interrupted/failed due to failed reception of SL-PRS at the target UE from one or more anchors because of, e.g.: non-line-of-sight (NLOS) channel condition between the target UE and anchor or high interference or resource conflict (e.g. such as SL-PRS collisions) at target UE, etc.

In the following,
first target UE-T1 is equivalent to the terminal apparatus 200 of FIG. 4,
second target UE-T2 is equivalent to the terminal apparatus 10 of FIG. 4,
anchor UE-A1 is equivalent to the reference apparatus 100 of FIG. 4,
interruption notification 20 is equivalent to positioning assistance information 20.

Referring to FIG. 7, consider SL-PRS reception at a mobile target UE-T2 at two different time instants. At time instant t1, UE-T2 successfully receives SL-PRS transmitted by anchor UE-A1. However, at time instant t2, the SL-PRS reception at UE-T2 fails due to obstruction of SL-PRS caused, for example, by a building. Consequently, the SL positioning session between UE-T2 and anchor UE-A1 is interrupted/failed.

The target UE needs to re-establish SL positioning session when the session 110 is interrupted/failed due to any of the aforementioned events where the SL-PRS transmission 102 from anchor UE-A1 is not successfully received by the target UE-T2.

However, the re-establishment of SL positioning session with another suitable anchor UE-A2 to replace the failed anchor UE-A1 will incur a large delay at the target UE-T2 since it involves e.g., anchor reselection, SL-PRS reconfiguration, etc. as described above. This large delay may not be acceptable for many SL positioning use cases, in particular for use cases corresponding to lower latency positioning service levels.

Early awareness of SL-PRS reception interruption at a target UE can enable the target UE to prepare and engage in SL positioning session interruption avoidance/minimization measures (e.g. anchor UE reselection before the current anchor UE fails).

Upon encountering/anticipating interruption at a second target UE 10 in reception of SL-PRS transmitted by first anchor UE(s) 100, the second target UE 10 sends an interruption notification 20 to a first target UE 200 on its (expected) inability to successfully receive SL-PRS 202 from first anchor UE 100. The first target UE 200 uses this notification 20 to determine the need for interruption avoidance/minimization measures for its own SL positioning.

In at least some examples the second target UE 10 is configured to:
perform SL positioning session with an anchor UE 100;
determine SL positioning interruption with an anchor UE 100;
determine whether or not to send an interruption notification 20 to peer UEs (first target UE 200);
send interruption notification 20 to the target UE 200 on its inability to continue SL positioning session 110 with the anchor 100 on certain/all code-time-frequency resources.

The interruption notification message 20 may contain:
cause of the interruption e.g. jamming, resource unavailability or inability to use certain SL-PRS pattern;
ID of the interrupted anchor UEs;
mobility pattern (e.g. velocity, trajectory, route information) of the second target UE Duration of interruption (lasting or temporary);
certain/all time-frequency SPS/any resources where the interruption is expected;
providing (introducing) potential alternative anchor node(s) for positioning and the corresponding SL-PRS configuration.

A first target UE 200 is configured to:
perform SL positioning session with the anchor UE 100;
determine whether or not to perform SL position session termination/modification based on the interruption notification 20;
perform SL positioning session termination with the anchor, anchor reselection or resource reselection based on the determination.

In at least some further examples the second target UE 10 is configured to:
perform SL positioning session with an anchor UE 100;
determine SL positioning interruption with an anchor UE 100;
receive interruption notification request 52 from other target UEs (first target UE 200);
send interruption notification capability information 50 to other target UEs (first target UE 200) which indicates its capability to send interruption notification pertaining to a set of anchor UEs 100;
determine whether or not to send an interruption notification 20 to peer UEs (first target UE 200) based on at least the received interruption notification request 52;
send interruption notification 20 to the target UE 200 on its inability to continue SL positioning session 102 with an anchor 100 on certain/all code-time-frequency resources.

The interruption notification request message 20 may contain:
set of anchor UE IDs which are of interest to the other target UE (first target UE 200);
mobility pattern (e.g. velocity, trajectory, route information) of the other target UE 200;
trigger conditions for sending interruption notification 20.

The interruption notification capability message 50 may contain:
set of anchor UE IDs for which it can provide interruption notification 20;
mobility pattern (e.g. velocity, trajectory, route information) of the second target UE 10.

A first target UE 200 is configured to:
perform SL positioning session 210 with the anchor UE 100;
receive interruption notification capability information 50 from the second target UE 10;
send the interruption notification request 52 to the second target UE 10;
determine whether or not to perform SL position session termination/modification based on the received interruption notification 20;
perform SL positioning session termination with the anchor 100, anchor reselection or resource reselection based on the determination.

The solution illustrated in FIG. 7 is based upon the fact that target UEs in an area experience similar conditions with respect to their SL communication with a common anchor UE 100, such that if another target UE 10 (referred to as second target UE) experiences an interruption with an anchor UE 100 it is beneficial to raise such awareness to the target UE 200 (referred to as first UE) in the same area.

This would allow the first UE 200 to prepare accordingly for such interruption i.e. to take e.g. interruption avoidance/minimization measures for its own SL positioning.

In this regard, a second target UE (UE-T2) 10 sends an interruption notification 20 to the first target UE (UE-T1) 200 when it encounters/anticipates interruption in reception of SL-PRS transmitted by the anchor UE (UE-A1) 100.

For example, consider UE-T1 (first target UE) and UE-T2 (second target UE) that are in two different vehicles moving on a highway lane to be performing SL positioning session with a static anchor UE-A1.

At a time instant t2, the reception of SL-PRS at UE-T2 is failed due to obstructing building. Then, UE-T2 sends an interruption notification to UE-T1 to raise awareness about interruption in reception of SL-PRS transmitted by the anchor UE 100 in the area. This allows UE-T1 to be aware of the potential upcoming SL-PRS reception interruption and it takes interruption avoidance measure by establishing SL positioning session 310 with alternative anchor UE-A2 100_n.

As a result, at the time instant when UE-T1 is in the area in which UE-T2 had sent interruption notification 20, UE-T1 can continue to position itself via positioning session 310 without hindrance since it can receive SL-PRS assistance from anchor UE-A2 (instead of UE-A1) without interruption.

Referring to FIG. 7, at stage 500, of the method 600 a first target UE-T1 and second target UE-T2 are in respective SL positioning sessions 210, 110 with the first anchor UE-A1. UE-T1 and UE-T2 are receiving SL-PRS assistance. For example receiving SL-PRS from UE-A1 to position themselves. Here, UE-T1 (first target UE) and UE-T2 (second target UE) are considered to be in two different vehicles moving on a highway lane and are performing SL positioning session with a static anchor UE-A1.

At stage 501, of the method 600, optionally UE-T2 sends (e.g. broadcasts) interruption notification capability information 50 to other target UEs (including UE-T1) which indicates its capability to send interruption notification 20.

The interruption notification capability message 50 may contain:
a set of anchor UE IDs for which it can determine SL-PRS reception interruption and provide interruption notification; and/or
mobility pattern of UE-T2 (e.g. trajectory, velocity, route info.), etc.

UE-T2 identifies itself as the interruption notification node (i.e., the UE that notifies other target UEs about interruptions) via
(i) unicast, that is by means of plurality of SL connections to other target UEs.
(ii) by broadcasting new interruption notification capability message 50.

At stage 502, of the method 600, UE-T1 sends the interruption notification request 52 to UE-T2.

The interruption notification request 52 may at least consist of one or more of:
set of anchor UE IDs which are of interest to UE-T1;
mobility pattern (e.g. speed vector, trajectory, route info) of UE-T1;
trigger conditions for interruption notification (e.g., minimum RSRP with respect to anchor UE below which the notification 20 is triggered or if there are interruptions for number of anchor UEs is above a certain threshold number);
duration and periodicity in which the UE-T1 is interested to receive interruption notifications.

In some examples, on receiving interruption notification capability information 50 from UE-T2, UE-T1 may request 52 UE-T2 to provide the interruption notification 20.

In other examples, UE-T1 may request (e.g. in unicast manner) the UE-T2 for the notification only when there is high similarity between their mobility patterns and/or UE-T2 is capable of providing interruption notification on those anchors which are of interest to UE-T1.

In these or other examples, UE-T1 may autonomously determine to send (e.g. broadcast) interruption notification request without having received interruption notification capability information from neighboring UEs.

At stage 503, of the method 600, as part of on-going SL positioning session (cf. Step-0), UE-A1 transmits SL-PRS 102 to at least UE-T2.

At stage 504, of the method 600, there is detecting 40 of degradation in radio link quality of the radio link 102 between the UE-T2 and the anchor UE-A1.

For example, UE-T2 fails to successfully receive SL-PRS transmitted by UE-A1 and hence an interruption is determined 40 with UE-A1. In this example, NLOS SL-PRS transmission due to building obstruction is assumed to be the reason for the unsuccessful SL-PRS reception at UE-T2.

In some examples, the interruption with anchor UE-A1 is determined 40 only when the interruption actually occurs.

In some examples, the interruption with anchor UE-A1 is determined 40 based on predicted/expected interruption with the anchor UE-A1.

In some examples, prediction of interruption on the expected UE-T2's trajectory can be based on history of Reference Signal Received Power (RSRP) measurements. In addition, UE-T2 may consider expected interruption rate (number of expected interruptions per unit time) as a criterion in the determination 40.

At stage 505, of the method 600 upon determining the SL-PRS reception interruption, UE-T2 determines 42 whether or not to send an interruption notification 20 to UE-T1 based on at least the received interruption notification request 52.

In some examples, UE-T2 may determine 42 to send UE-T1 the interruption notification 20 (e.g. in a unicast manner) only if there is high similarity between their mobility patterns and/or UE-T2 has determined interruption for those anchor UEs which are of interest to UE-T1.

In some examples, UE-T2 may autonomously determine 42 to send interruption notification 20 without any explicit request from UE-T1 (e.g. in broadcast manner). For example, UE-T2 may send the notification 20 every time it encounters SL-PRS reception interruption. Also, in the notification 20, UE-T2 may include IDs of all those anchors for which it encountered interruption.

In some examples, UE-T2 may determine, at first, the level of positioning accuracy/reliability degradation due to the interruption. If the accuracy/reliability level drops below a (pre-)configured level, UE-T2 determines 42 to send the interruption notification 20. In a further embodiment, if duration of the degradation i.e. the duration that the accuracy/reliability remains outside the tolerable levels is above a certain (pre)configured time duration, then UE-T2 determines 42 to send interruption notification 20.

In some examples, UE-T2 may determine 42 to send the notification 20 if level of abruptness of interruption is above a (pre-)configured threshold.

In some examples, the configuration on the level of abruptness is configured by the network (LMF). The LMF thus sets the rules on how deep and for how long a signal degradation should trigger 42 an interruption notification 20.

In some examples, the configuration on the level of abruptness is configured by the peer UE (that is, UE-T2 is configured by UE-T1 on what duration of interruption should trigger 42 an interruption notification 20).

At stage 506, of the method 600, UE-T2 sends interruption notification 20 to the target UE-T1 on its inability to continue SL positioning session 102 with an anchor UE-A1 on certain/all code-time-frequency resources.

The interruption notification message 20 may contain:
cause of the interruption e.g. jamming, resource unavailability or inability to use certain SL-PRS pattern. UE-T1 could then use this information to avoid using such resources;
ID of the interrupted anchor node;
mobility pattern (e.g. speed vector) of the second target UE-T2;
duration of interruption (lasting or temporary);
certain/all time-frequency SPS/any resources where the interruption is expected;
providing (introducing) potential alternative anchor node(s) for positioning and the corresponding configuration, plus additional related information for improved positioning;
interruption rate probability of corresponding trajectory/routes with respect to anchor UEs.

Stage 507, of the method 600, comprises, in dependence upon the received interruption notification message 20, determining 220 performance of pre-emptive action 230 in anticipation of degradation in the radio link 202 between the terminal apparatus 200 and the first reference apparatus 100_2.

For example, upon receiving interruption notification 20, UE-T1 determines 220 whether or not to perform 230 SL position session termination/modification based on the interruption notification 20 from UE-T2.

In some examples, UE-T1 may determine 220 to perform 230 SL position session termination/modification only when SL-PRS reception in its SL-PRS resources/configuration (used by UE-A1 to send SL-PRS to UE-T1) is expected to face interruption as indicated in the interruption notification 20.

In some examples, UE-T1 may determine 220 to perform 230 SL position session termination/modification only when there is high similarity between their mobility patterns.

In some examples, UE-T1 may determine 220 to perform 230 SL position session termination/modification only when the duration of the interruption is above a certain (pre-)configured threshold.

In some examples, UE-T1 may select an additional anchor UE for its SL positioning and may determine to not to terminate SL position session with the anchor indicated (UE-A1) in the interruption notification 20 unless the SL-PRS reception is interrupted at UE-T1. If the interruption occurs at UE-T1 with respect to UE-A1, UE-T1 makes use of SL-PRS transmitted from the additional anchor UE-A2.

At stage 508, of the method 600, upon positive determination in Step-7, UE-T1 performs 230 SL positioning session termination with the anchor UE-A1, anchor reselection or SL-PRS resource reselection. By this, UE-T1 avoids potential SL positioning session interruption and therefore can continue positioning itself without any hindrance or delay.

In some examples, UE-T1 triggers SL-PRS resource reselection by means of providing inter-UE coordination (IUC) information with non-preferred resources (resources in which the interruption is determined by UE-T2) to UE-A1 if the interruption is expected in the current SL-PRS resource (used by UE-A1 to send SL-PRS to UE-T1).

In some examples, during anchor UE reselection, UE-T1 may consider the alternative anchor UE(s) proposed by UE-T2 for SL positioning session.

At stage 509, of the method 600, target UE-T1 establishes SL positioning session 310 with the anchor UE-A2. In this example, UE-T1 is assumed to establish and carry out SL positioning session 310 with another anchor UE-A2 upon receiving interruption notification 20 on UE-A1 by UE-T2. By doing so, UE-T1 avoids any SL positioning session interruption which may otherwise would have potentially occurred due to potential reception failure of SL-PRS 202 transmitted by UE-A1.

The proposed solution enables a target UE to have early awareness of SL-PRS reception interruption. This allows the UE to engage in SL positioning session interruption avoidance/minimization measures (e.g. anchor reselection before the current anchor fails) so that it can continue to position itself without any hindrance/interruption or delay. This is particularly beneficial for positioning use cases such as V2X (autonomous driving) and IIoT (factory scenarios) which require very high availability and low latency positioning services.

FIG. 8 illustrates an example of a controller 400 suitable for use in an apparatus 10, 200. Implementation of a controller 400 may be as controller circuitry. The controller 400 may be implemented in hardware alone, have certain aspects in software including firmware alone or can be a combination of hardware and software (including firmware).

As illustrated in FIG. 8 the controller 400 may be implemented using instructions that enable hardware functionality, for example, by using executable instructions of a computer program 406 in a general-purpose or special-purpose processor 402 that may be stored on a computer readable storage medium (disk, memory etc.) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 10, 200 when loaded into the processor 402. The computer program instructions, of the computer program 406, provide the logic and routines that enables the apparatus to perform the methods illustrated in the accompanying Figs. The processor 402 by reading the memory 404 is able to load and execute the computer program 406.

The apparatus 10 comprises:
at least one processor 402; and
at least one memory 404 including computer program code the at least one memory 404 and the computer program code configured to, with the at least one processor 402, cause the apparatus 10, 200 at least to perform:
positioning 112 the terminal apparatus 10 in a first positioning session 110 using a radio link 102 with at least a reference apparatus 100;
detecting 40 degradation in radio link quality of the radio link 102 between the terminal apparatus 10 and the reference apparatus 100;
transmitting 12 positioning assistance information 20, via sidelink communication 30, to at least another terminal apparatus 200 in dependence upon the detected degradation in radio link quality of the radio link 102 between the terminal apparatus 10 and the reference apparatus 100,
wherein the positioning assistance information 20 is indicative of at least a degradation in the radio link quality of the radio link between the terminal apparatus 10 and the reference apparatus 100.

The apparatus 10 comprises:
at least one processor 402; and
   at least one memory 404 including computer program code,
   the at least one memory storing instructions that, when executed by the at least one processor 402, cause the apparatus at least to perform:
positioning 112 the terminal apparatus 10 in a first positioning session 110 using a radio link 102 with at least a reference apparatus 100;
detecting 40 degradation in radio link quality of the radio link 102 between the terminal apparatus 10 and the reference apparatus 100;
transmitting 12 positioning assistance information 20, via sidelink communication 30, to at least another terminal apparatus 200 in dependence upon the detected degradation in radio link quality of the radio link 102 between the terminal apparatus 10 and the reference apparatus 100,
wherein the positioning assistance information 20 is indicative of at least a degradation in the radio link quality of the radio link between the terminal apparatus 10 and the reference apparatus 100.

The apparatus 200 comprises:
at least one processor 402; and
at least one memory 404 including computer program code
the at least one memory 404 and the computer program code configured to, with the at least one processor 402, cause the apparatus 10, 200 at least to perform:
positioning 212 the terminal apparatus 200 in a second positioning session 210 using a radio link 202 with at least a first reference apparatus 100_2;
receiving from another terminal apparatus 10 positioning assistance information 20, via sidelink communication 30, wherein the positioning assistance information 20 is indicative of at least a degradation in radio link quality of a radio link 102 between the other terminal apparatus 10 and a second reference apparatus 100_1; and
in dependence upon the received positioning assistance information 20, determining 220 performance of pre-emptive action 230 in anticipation of degradation in the radio link 202 between the terminal apparatus 200 and the first reference apparatus 100_2.

The apparatus 200 comprises:
at least one processor 402; and
   at least one memory 404 including computer program code,
   the at least one memory storing instructions that, when executed by the at least one processor 402, cause the apparatus at least to perform:
positioning 212 the terminal apparatus 200 in a second positioning session 210 using a radio link 202 with at least a first reference apparatus 100_2;
receiving from another terminal apparatus 10 positioning assistance information 20, via sidelink communication 30, wherein the positioning assistance information 20 is indicative of at least a degradation in radio link quality of a radio link 102 between the other terminal apparatus 10 and a second reference apparatus 100_1; and
in dependence upon the received positioning assistance information 20, determining 220 performance of pre-emptive action 230 in anticipation of degradation in the radio link 202 between the terminal apparatus 200 and the first reference apparatus 100_2.

As illustrated in FIG. 9, the computer program 406 may arrive at the apparatus 10, 200 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 10, 200 may propagate or transmit the computer program 406 as a computer data signal.

Computer program instructions for causing an apparatus 10 to perform at least the following or for performing at least the following:
positioning 112 the terminal apparatus 10 in a first positioning session 110 using a radio link 102 with at least a reference apparatus 100;
detecting 40 degradation in radio link quality of the radio link 102 between the terminal apparatus 10 and the reference apparatus 100;
transmitting 12 positioning assistance information 20, via sidelink communication 30, to at least another terminal apparatus 200 in dependence upon the detected degradation in radio link quality of the radio link 102 between the terminal apparatus 10 and the reference apparatus 100,
wherein the positioning assistance information 20 is indicative of at least a degradation in the radio link quality of the radio link between the terminal apparatus 10 and the reference apparatus 100.

Computer program instructions for causing an apparatus 200 to perform at least the following or for performing at least the following:
positioning 212 the terminal apparatus 200 in a second positioning session 210 using a radio link 202 with at least a first reference apparatus 100_2;
receiving from another terminal apparatus 10 positioning assistance information 20, via sidelink communication 30, wherein the positioning assistance information 20 is indicative of at least a degradation in radio link quality of a radio link 102 between the other terminal apparatus 10 and a second reference apparatus 100_1; and
in dependence upon the received positioning assistance information 20, determining 220 performance of pre-emptive action 230 in anticipation of degradation in the radio link 202 between the terminal apparatus 200 and the first reference apparatus 100_2.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

In some but not necessarily all examples, the apparatus 10, 200 is configured to communicate data from the apparatus 10, 200 with or without local storage of the data in a memory 404 at the apparatus 10, 200 and with or without local processing of the data by circuitry or processors at the apparatus 10, 200.

The data may, for example, be measurement data or data produced by the processing of measurement data.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long-range cellular radio links. The apparatus may comprise a communications interface such as, for example, a radio transceiver for communication of data.

The apparatus 10, 200 may be part of the Internet of Things forming part of a larger, distributed network.

The processing of the data, whether local or remote, may be for the purpose of health monitoring, data aggregation, patient monitoring, vital signs monitoring or other purposes.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The processing of the data, whether local or remote, may produce an output. The output may be communicated to the apparatus 10, 200 where it may produce an output sensible to the subject such as an audio output, visual output or haptic output.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

As used here ‘module’ refers to a unit or apparatus that excludes certain parts/components that would be added by an end manufacturer or a user.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A terminal apparatus comprising:
at least one processor; and
at least one memory including computer program code, the at least one memory and the computer program code configured to, with the at least processor, cause the terminal apparatus at least to perform:
positioning the terminal apparatus in a first positioning session using a radio link with at least a reference apparatus;
detecting degradation in radio link quality of the radio link between the terminal apparatus and the reference apparatus;
transmitting positioning assistance information, via sidelink communication, to at least another terminal apparatus in dependence upon the detected degradation in radio link quality of the radio link between the terminal apparatus and the reference apparatus,
wherein the positioning assistance information is indicative of at least a degradation in the radio link quality of the radio link between the terminal apparatus and the reference apparatus.

2. The terminal apparatus as claimed in claim 1, wherein the radio link comprises reception of a radio positioning reference signal transmitted from the reference apparatus to the terminal apparatus and/or comprises transmission of a radio positioning reference signal from the terminal apparatus to the reference apparatus.

3. The terminal apparatus as claimed in claim 2, wherein the radio positioning reference signal is a sidelink positioning reference signal.

4. The terminal apparatus as claimed in claim 3, wherein the terminal apparatus is a target to be positioned and the reference apparatus is an anchor supporting positioning of the terminal apparatus in the first positioning session in a first sidelink network, and wherein the another terminal apparatus is a target to be positioned and the reference apparatus is an anchor supporting positioning of the another terminal apparatus in a second positioning session between the another terminal apparatus and the reference apparatus in a second sidelink network.

5. The terminal apparatus as claimed in claim 2, wherein the reference apparatus is a network node and the radio positioning reference signal is a downlink positioning reference signal transmitted from the reference apparatus to the terminal apparatus and/or the radio positioning reference signal is an uplink positioning reference signal transmitted from terminal apparatus to the reference apparatus.

6. The terminal apparatus as claimed in claim 1, wherein the detecting degradation in radio link quality between the terminal apparatus and the reference apparatus comprises detecting radio link failure or anticipating radio link failure based on measurement of radio link quality over time.

7. The terminal apparatus as claimed in claim 1, caused to perform determining the positioning assistance information at least in dependence upon the detected degradation in radio link quality of the radio link between the terminal apparatus and the reference apparatus.

8. The terminal apparatus as claimed in claim 2, wherein the positioning assistance information identifies at least one of the following:
an identifier of the reference apparatus;
a position of the reference apparatus;
a position of the terminal apparatus;
mobility pattern of the terminal apparatus;
positioning service level of the positioning session;
time-frequency resources of the radio positioning reference signal communicated over the radio link;
cause of degradation in radio link quality of the radio link between the terminal apparatus and the reference apparatus;
duration of degradation in radio link quality of the radio link between the terminal apparatus and the reference apparatus; or
information associated with alternative reference apparatus for positioning the another terminal apparatus in the second positioning session.

9. The terminal apparatus as claimed in claim 1, caused to perform transmitting an interruption notification capability via sidelink communication, to the another terminal apparatus in advance of transmitting the positioning assistance information, via sidelink communication, to the another terminal apparatus, wherein the interruption notification capability is indicative of a capability of the terminal apparatus to provide the positioning assistance information.

10. The terminal apparatus as claimed in claim 1, caused to perform receiving an interruption notification request via sidelink communication, from the another terminal apparatus in advance of transmitting positioning assistance information, via sidelink communication, to the another terminal apparatus, wherein the positioning assistance information is determined at least in dependence upon the interruption notification request.

11. The terminal apparatus as claimed in claim 10, wherein the interruption notification request comprises at least one of the following:
an identifier of reference apparatus positioning the another terminal apparatus in the second positioning session;
mobility pattern of the another terminal apparatus; or
condition for transmitting the positioning assistance information.

12.-13. (canceled)

14. A method performed at a terminal apparatus comprising:
positioning the terminal apparatus in a first positioning session using a radio link with at least a reference apparatus;
detecting degradation in radio link quality of the radio link between the terminal apparatus and the reference apparatus;
transmitting positioning assistance information, via sidelink communication, to at least another terminal apparatus in dependence upon the detected degradation in radio link quality of the radio link between the terminal apparatus and the reference apparatus,
wherein the positioning assistance information is indicative of at least a degradation in the radio link quality of the radio link between the terminal apparatus and the reference apparatus.

15. A terminal apparatus comprising:
at least one processor; and
at least one memory including computer program code, the at least one memory and the computer program code configured to, with the at least processor, cause the terminal apparatus at least to perform:
positioning the terminal apparatus in a second positioning session using a radio link with at least a first reference apparatus;
receiving from another terminal apparatus positioning assistance information, via sidelink communication, wherein the positioning assistance information is indicative of at least a degradation in radio link quality of a radio link between the another terminal apparatus and a second reference apparatus; and
in dependence upon the received positioning assistance information, determining performance of pre-emptive action in anticipation of degradation in the radio link between the terminal apparatus and the first reference apparatus.

16. The terminal apparatus as claimed in claim 15, wherein the radio link comprises reception of a radio positioning reference signal transmitted from the first reference apparatus to the terminal apparatus and/or comprises transmission of a radio positioning reference signal from the terminal apparatus to the first reference apparatus.

17. The terminal apparatus as claimed in claim 16, wherein the radio positioning reference signal is a sidelink positioning reference signal.

18. The terminal apparatus as claimed in claim 15, wherein the terminal apparatus is a target to be positioned and the first reference apparatus is an anchor supporting positioning the terminal apparatus in the second positioning session in a second sidelink network, and wherein the another terminal apparatus is a target to be positioned and the second reference apparatus is an anchor supporting positioning the another terminal apparatus in a first positioning session between the another terminal apparatus and the second reference apparatus in a first sidelink network.

19. The terminal apparatus as claimed in claim 15, caused to perform pre-emptive action comprising modifying the second positioning session and/or terminating the second positioning session.

20. The terminal apparatus as claimed in claim 15, caused to perform transmitting an interruption notification request via sidelink communication, to the another terminal apparatus, requesting the another terminal apparatus to provide the positioning assistance information.

21. The terminal apparatus as claimed in claim 20, wherein the interruption notification request comprises at least one of the following:
an identifier of the first reference apparatus positioning the terminal apparatus in the second positioning session;
mobility pattern of the terminal apparatus; or
condition for transmitting the positioning assistance information.

22. The terminal apparatus as claimed in claim 15, wherein the positioning assistance information identifies at least one of the following:
identifier of the second reference apparatus;
a position of the second reference apparatus;
a position of the another terminal apparatus;
mobility pattern of the another terminal apparatus;
positioning service level of the first positioning session positioning the another terminal apparatus;
time-frequency resources of radio positioning reference signal communicated in the first positioning session over the radio link between the another terminal apparatus and the second reference apparatus;
cause of degradation in radio link quality of the radio link between the another terminal apparatus and the second reference apparatus;
duration of degradation in radio link quality of the radio link between the another terminal apparatus and the second reference apparatus; or
information associated with alternative reference apparatus for positioning the terminal apparatus in the second positioning session.

23. The terminal apparatus as claimed in claim 15, caused to perform receiving an interruption notification capability via sidelink communication, from the other terminal apparatus in advance of transmitting the interruption notification request, via sidelink communication, to the another terminal apparatus, wherein the interruption notification capability is indicative of a capability of the another terminal apparatus to provide the positioning assistance information.

24.-25 (canceled)

26. A method performed at a terminal apparatus comprising:
positioning the terminal apparatus in a second positioning session using a radio link with at least a first reference apparatus;
receiving from another terminal apparatus positioning assistance information, via sidelink communication, wherein the positioning assistance information is indicative of at least a degradation in radio link quality of a radio link between the another terminal apparatus and a second reference apparatus;
in dependence upon the received positioning assistance information, determining performance of pre-emptive action in anticipation of degradation in the radio link between the terminal apparatus and the first reference apparatus.
